(19) United States
(12) Patent Application Publication
(10) Pub. No.: US 2008/0004910 A1
(43) Pub. Date: Jan. 3, 2008

(54) System and method for tracking injury data and assessing liability for compensation claims

(76) Inventor: Leonard J. Higgins, Beaumont, CA (US)

Correspondence Address: LAW OFFICES OF DAVID L. HOFFMAN, 27023 MCBEAN PKWY, SUITE 422, VALENCIA, CA, 91355, US

(21) Appl. No.: 11/899,377

(22) Filed: Sep. 4, 2007

Related U.S. Application Data
(62) Division of application No. 11/361,337, filed on Feb. 23, 2006.

(51) Int. Cl. G06Q 50/00

(52) U.S. Cl. 705/2

(57) ABSTRACT

A system capable of automatically testing the veracity of a claim of compensation for a physical or emotional injury, includes a standardized information database, an accumulated information data record, a checklist function wherein all allegedly compatible data fields are verifiable for consistency wherein the original facts and circumstances completely describing the nature and extent of the alleged injury are encoded in a novel form based on lay terminology. The accrued databases are designed to encompass a progressively accumulated data set following a preferred pattern including individually selectable optional lines of inquiry. The system automatically compares allegations of fact which allegations remain recorded in an unaltered form, for each and every relevant discovery of medical history or other relevant record of prior or subsequent fact. This comparison improves detectability of fraud and error which can otherwise occur due to the potential for the claim allegations to become materially altered or obscured. Use of the unique code structure preserves the essential facts and circumstances of the claim in a format compatible with electronic data processing, enabling cross-correlation testing to be repeatedly completed for every addition to the record achieving speed and thoroughness levels not possible by manual means.

### BACKGROUND OF THE INVENTION

1. Field of the Invention

The present invention relates to a system for tracking injury data and assessing compensation liability. More particularly, in one embodiment, the present invention relates to a system for assessing liability, e.g., for Workers' Compensation benefits when an injury is alleged by an employee to have arisen from and be within the scope of his or her employment. The invention preserve a true record of all evidence or the most significant evidence tending to prove or disprove the validity of the claim. This preservation allows comparative testing of all elements of the record using data processing technology and novel encoding to eliminate technical ambiguity and potential corruption of the record due to errors, omissions or insertion of conclusive statements.

2. Description of the Related Art

Expenditures for medical care form a very large and growing component of the economy. Advances in medical technology and the potential for protracted or catastrophic illness or injury contribute to a steady increase that is an important element of society. The large majority of expenditures is indemnified in one manner or another, by private insurance, Government benefits plans or various other ways including Workers' Compensation schemes that apply in most states in the United States.

Workers' Compensation Statutes are the result of a social compact made between the employers and workers that creates strict liability for work-related injury or illness in exchange for eliminating numerous lawsuits alleging liability for negligence or other reasons.

For a variety of causes ranging from simple error to even a sense of entitlement, fraud is a common problem. Many claims are compensated that should not be paid and many are overpaid as a result of providing medical care for ailments in addition to or other than work-related injuries.

In a typical workers' compensation claim, a medical provider examines the injured claimant and creates a medical report, expressing the injury in terms of a medical conclusion. A basic difficulty in preventing fraud, other than blatant misrepresentation detectable by ordinary analysis, is that expressing the injury in technical medical terms based on the interpretation of medical providers operating within the system makes it difficult to track and preserve the true or underlying data provided by the claimant in describing the injury symptoms.

Because claims evaluators are not expert medical analysts, it is quite common for the medical provider's medical conclusion in the workers compensation claim record to become the justification for compensating the claim. The medical conclusion in essence hides the true facts about the claimed injury. It is important to note that the medical provider's medical conclusion is not necessarily wrong, and the medical provider is not necessarily involved in distorting or overstating a claim. The medical provider has a duty to evaluate and treat the patient, not a duty to try to detect fraud. The medical provider can only evaluate based on the facts of the injury as provided by the claimant. In other words, if the claimant makes up a symptom such as a sharp pain in the wrist, the medical provider will try to make a diagnosis based on the type and location of the pain, and that diagnosis, e.g., sprained wrist, does not necessarily reveal the original symptoms.

These problems are compounded by the fact that most medical evaluators' office systems are based on a traditional antiquated hand-written approach to record keeping that invites errors of both omission and commission.

U.S. Published Patent Application No. 2003/0182159 discloses a process for structuring and summarizing key information for automated decision making for insurance underwriting. The patent abstract notes that “Most of the key information required for automated insurance underwriting is structured and standardized, except for Attending Physician Statement (APS).” The purpose is to assess medical impairment to decide whether to insure a person, and is not to record and continually verify a claimant's information concerning his or her injury. In addition, the system relies on the medical report, instead of getting to the underlying patient-provided facts.

To solve this basic problem, a system of preservation of all of the facts and circumstances of the original injury allegations is needed, along with a method of automatically verifying the consistency and corroboration of the allegations against existing records as they are discovered and added to a body of evidence in a file.

### SUMMARY OF THE INVENTION

In one embodiment of the invention, a system for assessing a claim for compensation for injury provides a standardized information data base, a checklist arrangement linked to the standardized information data base and a verification procedure so as to provide a more efficient and accurate method of assessing potential liabilities.

A preferred aspect of a preferred embodiment of the invention also provides a system for assessing an injury compensation claim, wherein inconsistencies, factual errors or false assertions of fact are identified so as to reduce the incidence of unjustified compensation of claimants.

A further preferred aspect of a preferred embodiment of the present invention is to provide a system for assessing an injury compensation claim, wherein a checklist guides data entry personnel in such a manner as to ensure that all elements of needed data are stored enabling a complete review of the claim and a check of the entire claim to detect inconsistencies in the stored data or inconsistencies in the stored data and newly inputted or newly provided data.

A further preferred aspect of a preferred embodiment of the present invention is to provide a system for assessing an injury compensation claim, wherein the verifiable record contains data from prior or subsequent medical records such that the data of the instant claim is cross-referenced to detect inconsistencies when contradictory data is obtained.

A further preferred aspect of a preferred embodiment of the present invention is to provide a system for assessing an injury compensation claim, wherein the verification arrangement further incorporates applicable statutes, administrative rules, and case law such that when the data of the instant claim is cross-referenced the detection of an issue related to such applicable law, rules, and regulations will prompt a more detailed review of the facts and circumstances related to any such identified issue.

A further preferred aspect of a preferred embodiment of the present invention is to provide a system for assessing an injury compensation claim, wherein standardized codes are used in a consistent fashion to define the essential elements of the injury occurrence sufficient to assess any medical consequences without the need for technical medical terminology such that the entire unambiguous statement of the original claim allegation is preserved for the record and can be input by non-expert data entry personnel.

A further preferred aspect of a preferred embodiment of the present invention is to provide a system for assessing an injury compensation claim, wherein standard codes are used in a consistent fashion for encoding inputted data, such that the verification process incorporates examination of all the codes contained in the record in an efficient and economical fashion to detect any anomalies, inconsistencies, discrepancies, or correlations between such codes occurring in any part of the record of the claim.

A further preferred aspect of a preferred embodiment of the present invention is to provide a system for assessing an injury compensation claim, wherein a simple standard code representing anatomical locations of the human body is arranged in a hierarchical system defining the place on any body part that an injury may be alleged to have occurred.

A further preferred aspect of a preferred embodiment of the present invention is to provide a system for assessing an injury compensation claim such that the content of a medical or other record is summarized in a manner that preserves a consistent and unambiguous record of the original allegation of injury occurrence so as to facilitate manipulation of the representative data by electronic data processing to detect inconsistent allegations by comparing data located in identifying fields of the process.

A further preferred aspect of a preferred embodiment of the present invention is to provide a system for assessing an injury compensation claim wherein contradictions of fact asserted in support of a claim of injury are detected by comparison of entries of data in corresponding fields of the process.

Accordingly, in order to achieve the above a most preferred embodiment of the present invention provides a method and system for assessing an injury compensation claim alleged by a claimant having:

A standardized information database for assembling a record of injury claim data from the claimant and other relevant sources wherein the injury claim data contains all of the original allegations of the claimant and a standardized code representative of the original allegation of injury, as an evidentiary record.

A checklist arrangement linked to the standardized information database to direct the identity, nature, and extent of data required to be collected to complete all essential fields so as to assure the ability to complete a comprehensive review of the entire claim record to detect and identify the source of any contradictions of claimed fact.

A verification process including a claimed injury reference database containing equivalent representative facts and circumstances linked to a standard database in such a manner that the claimed injury allegations of fact are compared with a discovered record to detect and identify the source of disputed issues of alleged fact.

These and other embodiments, features, and advantages of the present invention will become apparent from the following detailed description, accompanying drawings, and the appended claims.

### BRIEF DESCRIPTION OF THE DRAWINGS

FIG. 1 is a block diagram of a computer hardware system which may be used in a system for assessing a compensation claim according to a preferred embodiment of the present invention;

FIG. 2 is a block diagram illustrating components of the system for assessing a compensation claim according to the preferred embodiment;

FIGS. 3 and 4 illustrate an anatomical encoding scheme of the system according to the preferred embodiment. FIG. 3 showing a front of a human body in schematic form and FIG. 4 showing a rear of the body;

FIG. 5 illustrates an additional aspect of the anatomical encoding system for a spine of a human body;

FIG. 6 is a flow diagram illustrating the system according to the preferred embodiment;

FIG. 7 is a schematic diagram, of sample data stored in the system according to the preferred embodiment;

FIG. 7A is a schematic view of a table containing columns for entry of data in a more detailed variation of FIG. 7;

FIG. 7B is a schematic view of drop down menus for use in filling in data fields in the table of FIG. 7A;

FIG. 8 is a flow diagram of a portion of FIG. 6; and

FIG. 9 is a flow diagram illustrating the process for assessing an injury compensation claim according to an alternative embodiment of the present invention.

### DESCRIPTION OF THE PREFERRED EMBODIMENT(S)

In a preferred embodiment, the present invention provides a tool that enables claims examiners, not necessarily versed in the medical sciences, to quickly, accurately and consistently determine the validity of a claim as information is gathered that records the medical consequences of prior or subsequent events causing or affecting illness or injury.

The invention has broad application in the medical and claims analysis fields. In a preferred embodiment, it has particular significance in the field of workers' compensation (“WC”). WC insurance is mandated in one form or another whenever employees perform services for the benefit of an employer. What distinguishes this indemnification is the social contract that exists creating strict liability for workplace injuries in order to eliminate litigation by employees encountering such workplace injuries. Once a workplace injury is proven, only the nature and extent of medical consequences remain at issue in determining compensation under the particular provisions of most if not all WC plans.

Insurers in these cases may be insurance companies offering policies in compliance with the local plan (the WC plan for the state where the employee works), or self-insured employers. A special problem exists in such schemes in that once an allegation of injury has been evaluated by medical personnel or experts, the claim may become “medicalized”. Under these circumstances a medical opinion on the record will be substituted for the original facts and circumstances of the injury claim and the original chain of causation is lost. Once lost, the facts of the claim are not subject to adequate evaluation in determining the validity of the claim.

Moreover, causation and medical consequences of alleged injury are expressed in medical terms of art. Those normally engaged in evaluating claims are not sufficiently familiar with the medical terms to exercise adequate judgment as to the validity of any argument of cause and effect on which the claim must depend. Further, sometimes multiple medical terms can be used to refer to the same cause or effect, making evaluation even more difficult.

To solve such problems, a preferred embodiment of the invention uses data comparison steps most conveniently and efficiently implemented by computer program, combined with a unique coding scheme that defines the nature and circumstances of an injury in terms of its original alleged facts and in a consistent form. The coding system uses an anatomical location descriptor that uniquely preserves the facts and circumstances of the original allegation, defining the claim along with the rest of the record in an unambiguous fashion that is medically sufficient but not reliant on any medical opinion or terminology.

The rest of the facts and circumstances defining the record are also subjected to comparative review to determine any inconsistency that would indicate an invalid claim.

The system provides a procedure so that clerical data entry operators can record all essential data defining the claim as more facts are determined. Any discrepancy between the original alleged facts and circumstances and those subsequently determined or observed from differing sources automatically generates a special report inviting detailed evaluation of the incompatible records thus identified.

The preferred implementation allows an entire claim file to be reviewed as additional data is acquired at random in a fashion that guides the entry of the data to eliminate errors. Errors are immediately detected by inconsistencies that can be eliminated by detailed review.

Consistent, thorough, and accurate recording and review of claims is carried out in this manner at low cost and to an extent not practicable using conventional attempts to evaluate and understand the medical record commonly encountered when reviewing claims.

The preferred implementation further addresses the workers' compensation problem that is particularly acute in the State of California. In the absence of a controlled formalized review process such as that presented by the preferred embodiment of the instant invention, current procedures allow as much as 80% of all compensation to be paid out improperly (due to fraud and error), which is enabled as a result of corruption and/or obfuscation of the record of facts supporting the claim. By automatically assessing all comparative data in the record and compelling adherence to the original facts of the claim, the eradication of exaggeration, distortion, and unwarranted causation records dramatically reduces unjustified compensation.

Common methodology primarily tries to efficiently distribute benefits based on the assumption that a claim is justified. The preferred embodiment of the instant invention preserves the integrity of the file or record, preventing the substitution of opinion for fact and imposes a reconciliation discipline on the claim procedure, before a claim is allowed to proceed.

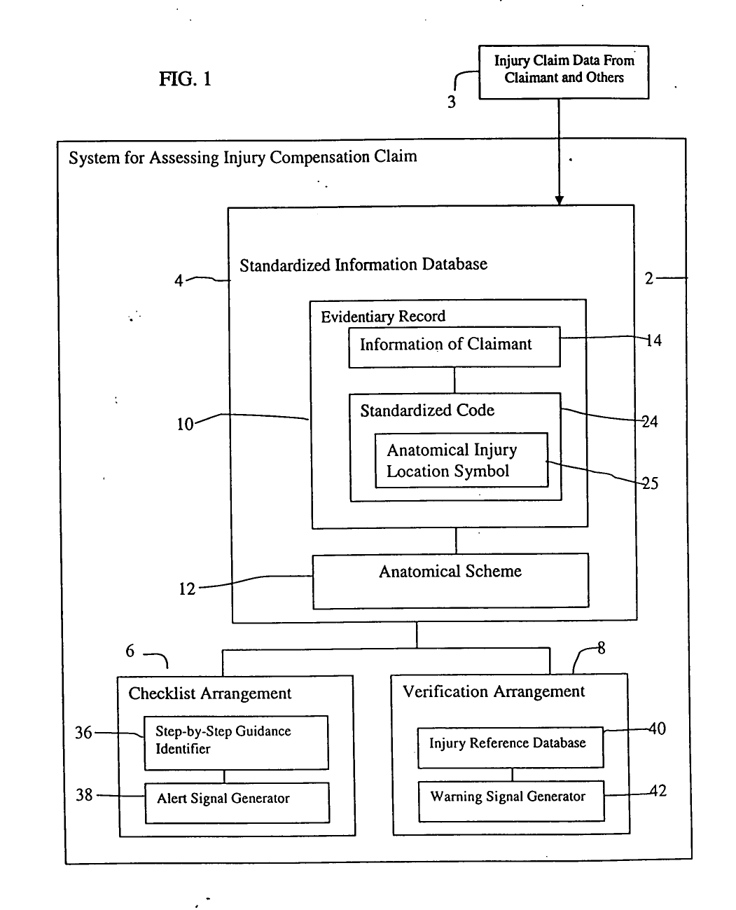

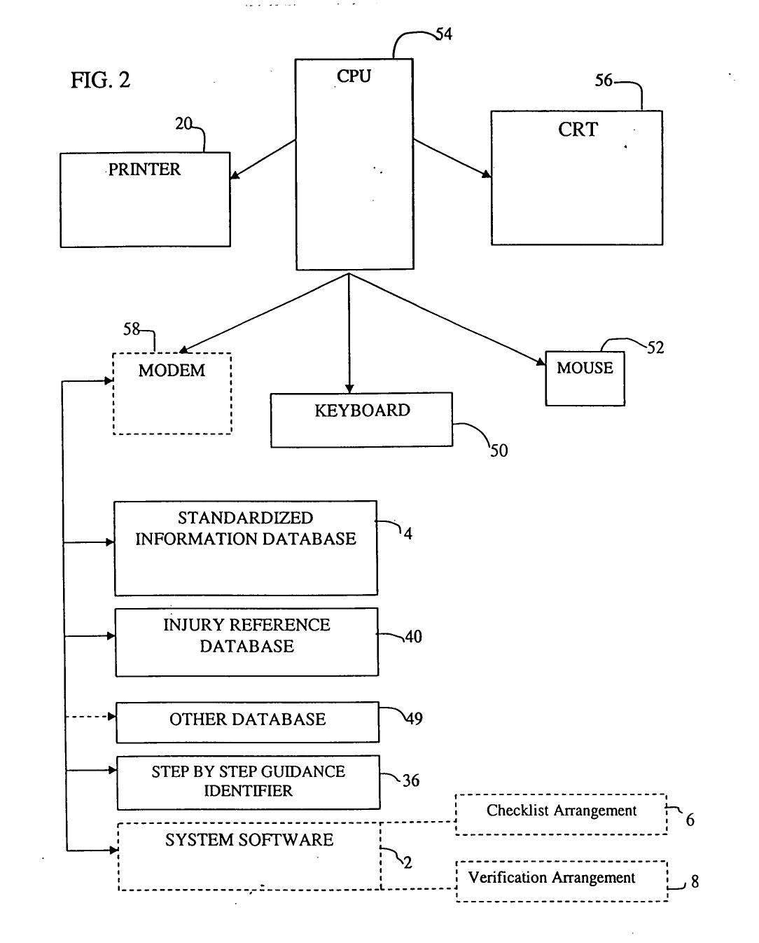

With reference to FIGS. 1 and 2, a system 2 for assessing an injury compensation claim is illustrated according to a preferred embodiment of the present invention. The system 2 includes a standardized information database 4, a checklist arrangement 6, and a verification arrangement 8. When system 2 is embodied as a computer program, the database 4 may be controlled by standard database software, e.g., relational database software and database 4 is stored on a machine readable medium, such as a hard drive, a disk, a CD ROM or other media. Checklist arrangement 6 may be programmed as a standard set of instructions and questions, using e.g., EXCEL® software. Verification arrangement 8 may be programmed using software suitable for making comparisons of data, e.g., EXCEL® software. Relational database software may also be used.

The standardized information database 4 is designed to ensure collection of a comprehensive data set defining all relevant facts and circumstances of the claim (input claim data 3, e.g., using a keyboard 50 and/or mouse 52) and a standardized code 24 designed to unambiguously represent the nature of the claimed injury.

In the ordinary course of events a claim for compensation must be supported by information in approved form containing all essential facts and circumstances of the allegation of injury.

In addition, a claim will be further supported by the report of a medical provider describing the history of injury as furnished by the claimant during a medical examination, a conclusion as to whether or not an injury has in fact occurred, a conclusion as to the cause thereof, a diagnosis, and a report of needed treatment along with other certifications specified by applicable rules.

At this point of the procedure there is a serious risk of corruption of the Record for a multiplicity of reasons including the typical provider's failure to compare the account given by claimant with other relevant data in the Record, advocacy on the part of the medical provider for the claimant in view of the medical provider's medical duty to the claimant (who necessarily becomes a patient of the provider upon the medical examination), errors of omission and commission by the provider when there is a conclusion that a compensable injury has occurred, based on a medical opinion. As noted above, the medical provider's report including the opinion becomes part of the record.

Because it is common practice for a claim evaluator lacking the medical expertise to critically analyze a medical report and causation discussion to simply rely on a provider's expert conclusion, it is quite common for an inaccurate or controvertible medical conclusion to become incorporated into the record as an apparent fact that can cause the true facts to be ignored or omitted from the record.

To prevent this, the standardized information database is designed to store all original claim information including the claimant's stated symptoms (e.g., type of pain and location of injury) from the alleged injury (to the medical provider and others) as an evidentiary record in a systematic fashion such that the original facts and circumstances of the injury allegation are preserved without corruption for comparison with independent sources of corroborating or contradictory data accumulated through the discovery process.

The standardized code of the information database includes an anatomical injury location symbol which is a code derived from a plain language (nonmedical language) unambiguous representation of the original allegation of injury occurrence related by the claimant and from other relevant records of the alleged event.

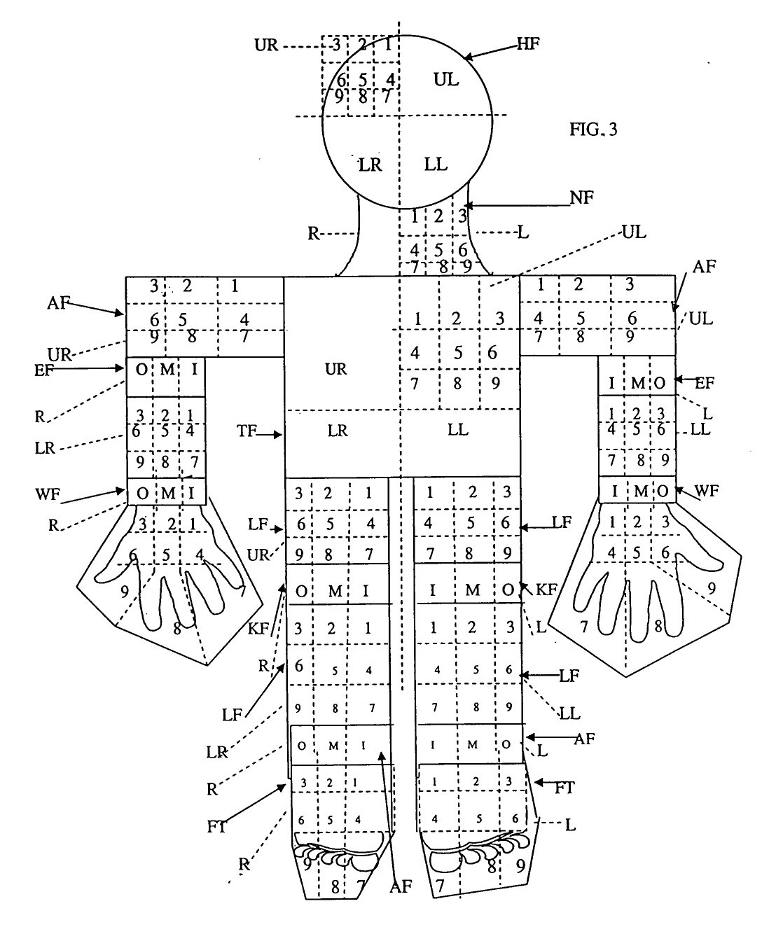

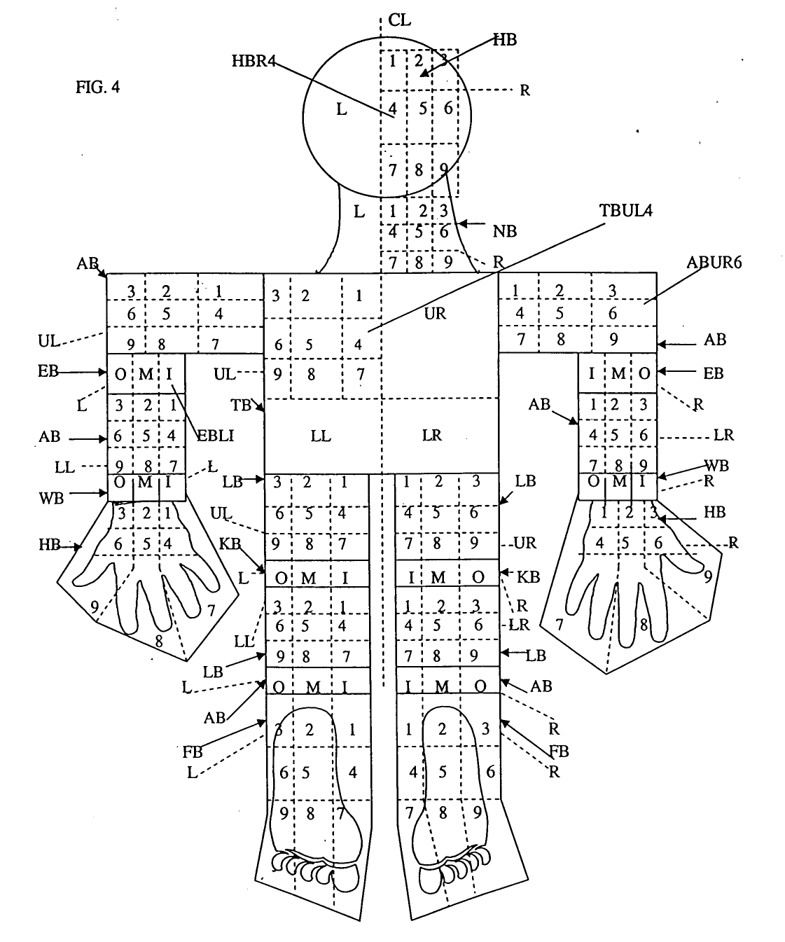

With reference to FIGS. 3, 4 and 5, in a preferred embodiment, the anatomical injury location symbol (“AILS”) 25 is derived by putting together four sets of abbreviations. FIGS. 3 and 4 show the front and back of a body with the anatomical scheme 12 for generating the AILS 25 (see FIGS. 1 and 2), which AILS is or is part of the standardized code 24. In FIGS. 3 and 4, the dashed line CL represents the center line of the body. The AILS is a code to identify the place on the body where the claimant first alleged that he or she detected a symptom of an injury.

The AILS is derived by dividing the body into readily recognizable areas. For example, the AILS may have a first portion which defines the body part where the claimant stated that the injury occurred and a second portion that defines whether the front or back (or top or bottom) of the body portion is where the injury occurred. For example, the first and second portions of the AILS may include the “head front (HF),” “head back (HB),” “neck front (NF),” “neck back (NB),” “torso front (TF),” “torso back (TB),” “arm front (AF),” “arm back (AB),” “elbow front (EF),” “elbow back (EB),” “wrist front (WF),” “wrist back (WB),” “hand front (HF),” “hand back (HB),” “leg front (LF),” “leg back (LB),” “knee front (KF),” “knee back (KB),” “ankle front (AF),” “ankle back (AB),” “foot top (FT),” and “foot bottom (FB).” Note that in the above, the hand and the head may have the same representation for this portion of the code, so the hand could be represented by another letter or by “Ha” or other differentiation. In addition, since the head will have four grids and the hand only two as discussed below, these other portions of the code below will be different to uniquely identify the head or the hand. In such case, the back of the head will need four grids too. Again, if the back of the head has two grids as shown in FIG. 4, then the code can have an “Ha” for the hand or other differentiation.

Each body part is then further subdivided by identifiable grid locations. The AILS may thus have a third portion which indicates the grid on the body part. For example, the head front (HF) may be divided into four grids. The first grid is upper left (UL), the second grid is upper right (UR), the third grid is lower left (LL), and the fourth grid is lower right (LR). For the arms, UL and LL are on the left arm and UR and LR are on the right arm. For the legs, the same grid pattern may be used. Each of the other body parts are divided into grids too.

Certain body parts will have fewer grids. For example, the elbow, wrist, hand, knee, ankle and foot will have fewer grids. For the “elbow front (EF),” there may be two grids which may just be represented by “left (L)” or “right (R).” The same for the “foot top,” and each portion of the other of these generally smaller body parts. Also, the back of the head may just have two grids, “left (L)” and “right (R).”

The AILS may thus have a fourth portion which indicates the place in the grid where the injury occurred. For the larger body parts, such as arms, legs, head, and torso, and also the feet, hands, and neck, each grid can be a three by three column and row arrangement, with the first row number 1, 2, 3, the second numbered 4, 5, 6, and the third row numbered 7, 8, 9. Certain parts like the elbow, wrist, knee and ankle will have smaller grids, and e.g., may have a grid which is just one row such as “inside (I),” “middle (M),” and “outside (O).”

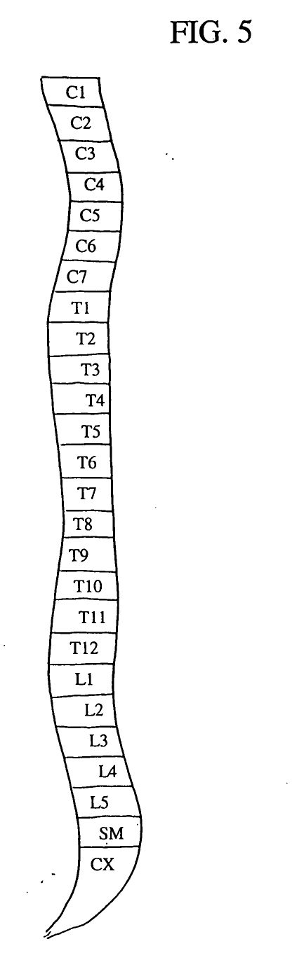

The “spine (S)” may be broken down by unique codes too, e.g., “S” followed by “C” and a number, or “T” and a number, or “L” and a number to indicate which vertebrae is where the injury occurred, C1 to C7, T1 to T12, or L1 to L5. For the sacrum and coccyx, the codes “SM” and “CX” could be used. See FIG. 5.

Using the above encoding scheme, an injury at the bottom of the left foot could be encoded as “FBL_” with the blank being a number in the grid where the injury occurred, e.g., FBL4. An injury in the back of the head at the lower left could be encoded as “HBLL_” with the blank being a number in the grid where the injury occurred, e.g., HBLL6. In FIG. 4, various example injury locations (pain locations) are shown with their codes:
Head Back Right Grid Space 4 is HBR4;
Torso Back Upper Left Grid Space 4 is TBUL4;
Arm Back Upper Right Grid Space 6 is ABUR6; and
Elbow Back Left Inside is EBLI.

Thus, the encoding scheme in one embodiment is:

[BODY PART CODE]+[FRONT, BACK, TOP OR BOTTOM OF THAT BODY PART]+[GRID WITHIN THE BODY PART]+[SPACE WITHIN THE GRID].

The purpose of dividing the locations on the human body systematically in the above manner is to provide a sufficiently accurate yet simple symbol to preserve a record of the original allegation of injury occurrence in lay terms that are easily understood but nevertheless sufficient to preserve the facts needed by a medical expert to reach an informed conclusion as to whether or not an injury actually occurred and the extent of the injury.

This system is easily understandable by non-expert claim evaluators and preserves an original record of the facts and circumstances of an alleged injury occurrence in terms that are unambiguous and not confused by medical diagnostic conclusions or expert discussion.

Furthermore, the encoded definition of injury location preserved in the record facilitates repeated verification checking for consistency with all additional relevant records as they are accumulated through the discovery process.

In addition, the anatomical location subdivisions and related grid locations forming the anatomical scheme 12 are made sufficiently precise as to prevent an incorrect medical conclusion concerning adjacent or related locations requiring medical attention for some reason other than the consequences of the alleged injury of the claim.

According to the preferred embodiment, the standardized information database incorporates an anatomical coding scheme for depicting a plurality of injury locations. Data entry personnel are able to record precise facts that preserve a record of the original claim of injury in a durable unambiguous fashion that enables repeated testing by automatic means to detect any lack of corroboration or contradiction that might be developed through directed discovery.

The AILS 25 and coding scheme 12 are language independent and useable in administrative procedures that may be used internationally.

The evidentiary record 10 of the standardized information database 4 is represented in a plain language protocol so that an unambiguous easily understood record effectively replaces medical expert terminology allowing testing by electronic means and reduced potential for specious technical argument.

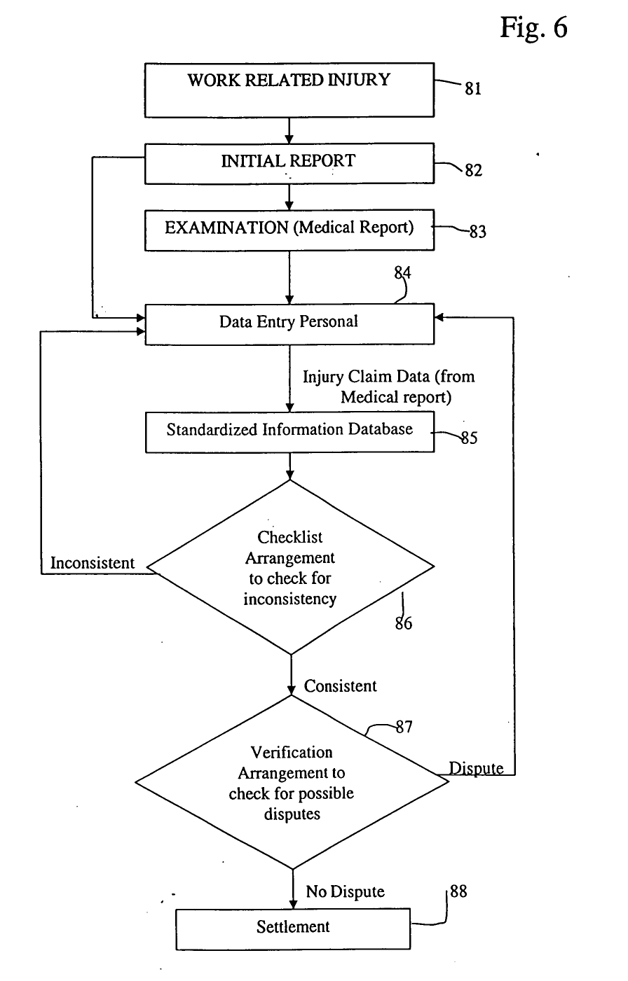

With reference to FIGS. 1 and 6, the checklist arrangement of a preferred embodiment of the present invention is linked to the standardized information database to direct the insertion of needed data into all essential fields of the system to ensure a complete and systematic compilation of the record of the claim.

To properly evaluate the merits of a claim of injury a complete data set must be input to the record to define all of the relevant facts and circumstances of the alleged claim of injury.

The completeness of the above information is vital to proper determination of the merits of the claim and whether or not the claimant is entitled to obtain benefits. In a simple example, if a claimant was not actually performing a service for an employer at the time of injury there would be no compensation liability created by WC laws.

In order to effectively monitor input data to ensure the compilation of a complete record, the checklist arrangement controls the input of data in step-by-step guidance through prompting of the data entry clerk to complete each required field with no allowed omissions. This speeds up data entry and assures the quality of compilation of the claim record.

The checklist arrangement 6 includes a step-by-step guidance identifier 36 requesting (prompting for) the injury claim data in a comprehensive manner to keep input of injury claim data consistent. When data entry personnel enter the injury claim data into the standardized information database 4, the step-by-step guidance identifier 36 will prompt the data entry personnel to fill in one field after another, so as to guide the data entry personnel to fill in all essential fields. No essential field would be left unfilled. Therefore, information needed by the indemnifier will be input to the standardized information database 4.

In practice, the time required for data entry personnel to input a particular set of injury claim data will become shorter, since the data entry personnel become familiar with the routine of what is needed at each step of the process. Only minimal training is required to realize these advantages.

According to the preferred embodiment, the checklist arrangement 6 further incorporates an alert signal generator 38 which is linked to the guidance identifier 36. The alert signal generator 38 is activated when comparison testing detects any inconsistency to notify the data entry clerk that an error has occurred.

Furthermore, if the alert is triggered by detection of an inconsistency in the record 10 rather than an input error a flag is generated signaling the existence and identity of contravening records requiring detailed review and evaluation.

The above process allows repeated 100% checking of the record 10 by electronic data processing each time an update is input. This degree of efficiency is completely impracticable by manual processing as well as time consuming to the point of being prohibitive in labor costs.

The verification arrangement 8 of the system for assessing potential injury compensation liabilities comprises a reference database 40 incorporating equivalent declarations of facts and circumstances defining the alleged injury linked to a standardized information database 4 so as to permit ready comparison testing between allegations of fact and recorded instances of fact on the record 10. Based on standard principles of detection, detected inconsistencies identify sources of conflicting information and identify potential issues at electronic data processing speed and without operator expenditure of duplicative labor hours.

The reference data 40 has a first data set compiled from sources reporting the facts and circumstances of the alleged injury along with all relevant declarations of the claimant in support of the claim.

A second data set has reference data such as medical records, employment records, social security records, WCIRB (workers' compensation injury review board)[?] records, and other data summarized in accordance with the field identity dictates of the standardized reference database 4 compiled in an iterative process based on prompts or directions of the system 2 to obtain further data. Spare fields are provided to accommodate the incidence of unplanned lines of inquiry, as needed. This process and a typical list of data sources are illustrated below:

All of the input data of the claim of injury is compared in a verification process with each and every item of like data as additions are made to the record 10, to detect and identify the source of any inconsistency between alleged declarations of fact or circumstance and discovered records of such facts or circumstances.

In order to provide an alert upon the detection of any discrepancy, the verification process incorporates a warning signal generator 42 which serves multiple purposes of directing the need for investigative action and identification of the discrepancy in the data sources requiring investigation.

When warnings occur, a report may be printed on a printer 20 to show the areas of conflict and/or the report may be stored in the system, e.g., at other database 49. When embodied as a computer program, system 2 would be run on a CPU 54, and the various checklist arrangement 6 prompts for data entry would appear on a CRT 56 (or other monitor). The databases and even the software of the system itself may be located locally where data entry occurs, or some or all may be located remotely and accessed by intranet or internet, e.g., by modem 58.

The preferred embodiment incorporates the standard code delineating the claim in a consistent unambiguous format capable of manipulation in a fashion identical to or compatible with the format of the injury reference database 40.

Because the standardized code is able to fully complement the capability of a claimant to state symptoms alleging the occurrence of injury, the record preserves the original unadulterated declaration of the claimant enabling this to be evaluated consistently for the entire duration of the claim.

According to the preferred embodiment, the reference data of the injury reference database 40 incorporates a second database containing essential laws, rules, and regulations of the jurisdiction under which liability is sought to be established by the claim. For example, the application of the preferred embodiment to a WC claim in the State of California incorporates the law, rules, regulations, and procedural data of the Workers' Compensation Appeals Board, or its successor if there should be any such.

When the injury claim data is compared with the reference injury data of the injury reference database of the verification arrangement, the applicable laws, rules and regulations contained in the second data will be prompted for the claim agent to review, so as to provide a guide for the claim agent to better estimate the compensation.

An example of how a preferred embodiment of the invention would work may be described with reference to the drawings, primarily, FIGS. 6, 7 and 8, in a medical compensation scheme such as WC.

Upon an injury or alleged injury, as shown by step 81, a worker reports an injury to another employee or outside agency responsible for administering WC claims. The injury claim data as alleged by claimant is taken as an initial report 82 and may be directly input into the system 2 (embodied as a computer program using a computer system as shown in FIG. 2) or may subsequently be input by data entry personnel at step 84.

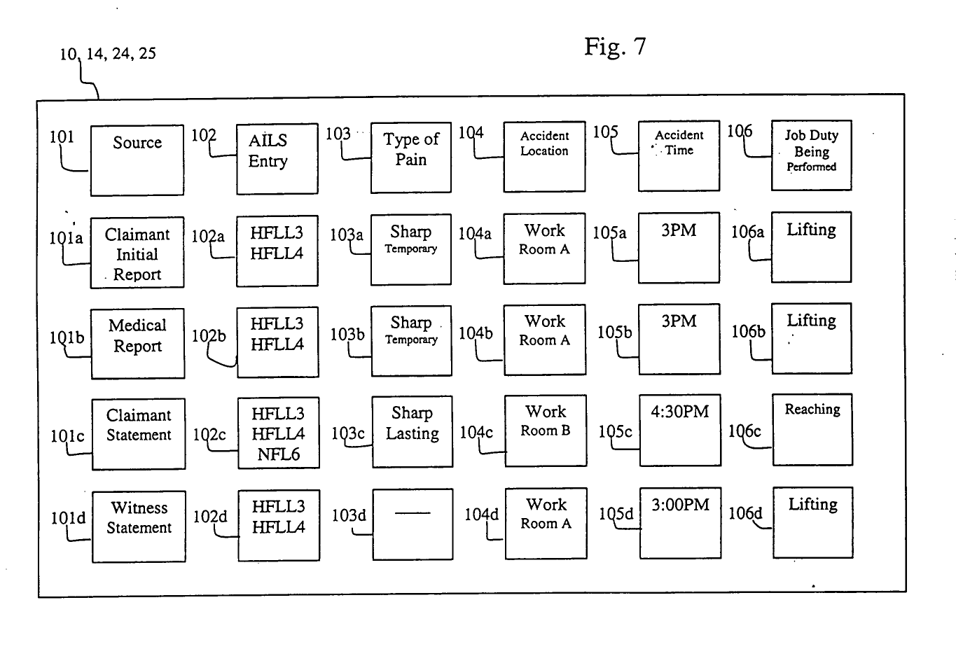

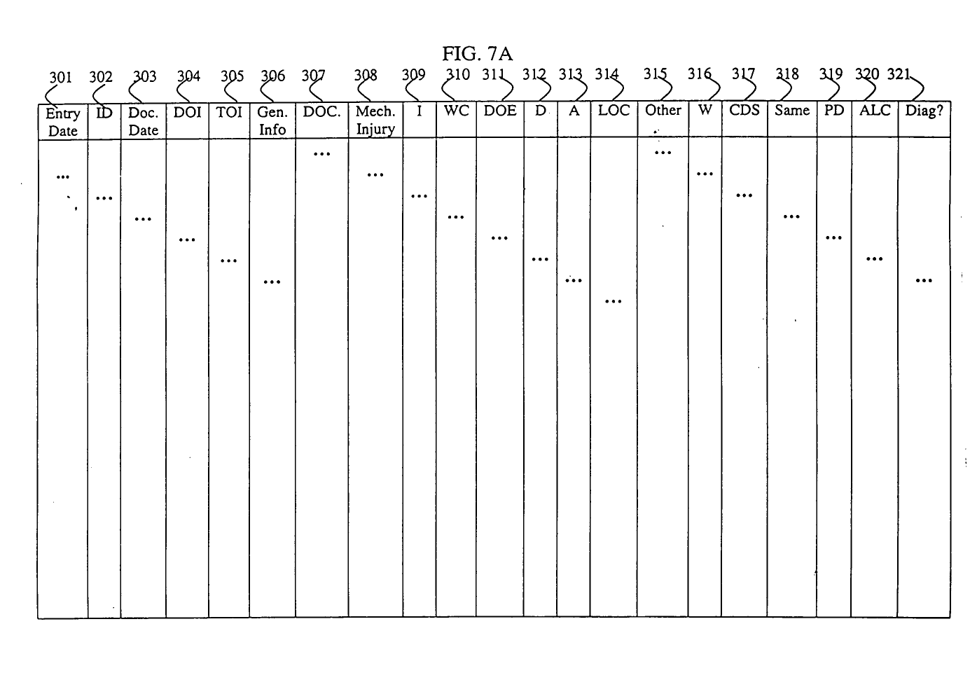

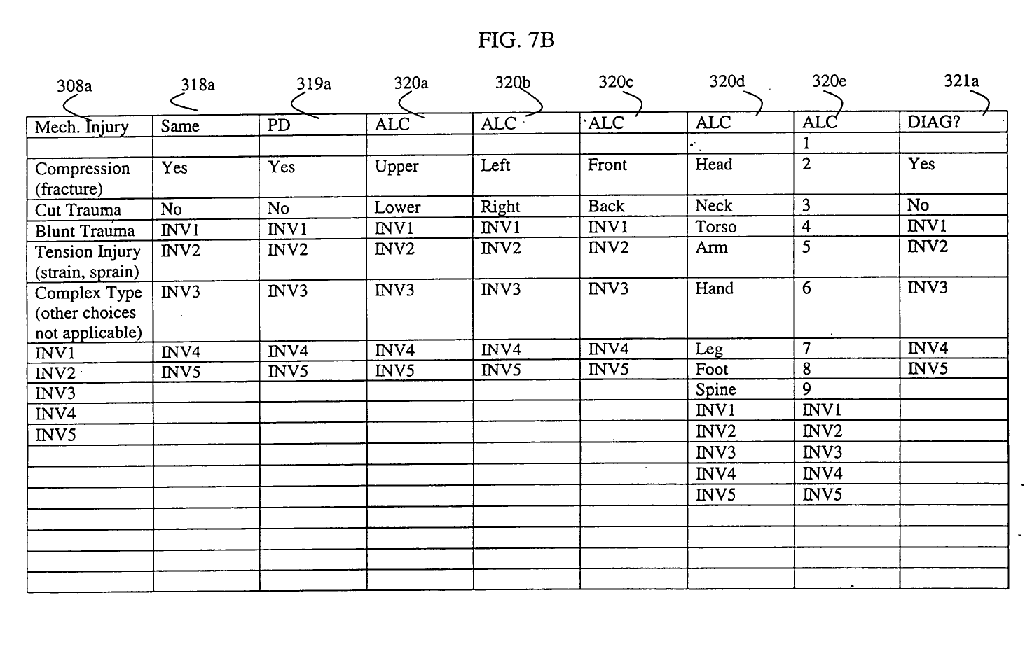

The initial report data, as shown in FIG. 7, may be listed in a memory column for entry of source 101 of the data, which is the claimant's initial report 101a. Other data would include the AILS 25 for this injury, e.g. HFLL3 and HFLL4 (location in AILS 25 derived from anatomical scheme 12 for an injury to the front lower left grid of the face in grid spaces 3 and 4. In addition to the AILS entry 102a, AILS column 102 of the record 10 (stored in information of claimant 14, standardized code 24 and AILS 25), there may also be a column, for type of pain 103 e.g., “sharp temporary,” if such is reported by claimant. In FIG. 7, it is “sharp temporary” at 103a. The universe of pain “types” is preferably stored in the system in the checklist arrangement which prompts for this information.

Additional information that the initial report would contain in this embodiment would be facts concerning where the accident occurred and when, to establish whether or not the claimant was “at work” and “in the course of” work for purposes of a WC claim. Accordingly, checklist arrangement 6 might ask in step 82 of the initial report, where the claimant was and provide a universe of locations suitable for claimant's job, e.g., “Work Room A” stored at 104a in the record 10. Checklist arrangement 6 might then ask the time (and date) of the accident at column 105, and the answer might be, e.g., “3 pm,” stored at 105a. Checklist arrangement 6 might next ask the job task out of a universe of job tasks or activities, and the answer might be “lifting” stored at 106a in a column 106.

Claimant might also provide personal information such as name, address, telephone number, social security number, etc., which the checklist arrangement 6 might ask for and store this information at information of claimant 14 in the system 2.

The claimant will then go to a medical provider where a doctor will examine claimant and provide a medical report. This is step 83. At step 84, data entry into system 2 from the medical report is performed. The same “source,” “AILS entry,” “type of pain,” etc. information entered into the databases for record 10 will be entered at 101b, 102b, 103b, 104b, 105b and 106b. Step 85 represents the system 2 storing the information in the standardized information database 4.

Now the checklist arrangement 6, at step 86 looks to see whether or not any data entered from the medical report is inconsistent with any data from the claimant's initial report. In the example in FIG. 7, there are no discrepancies here. If an inconsistency is found, one would check the underlying reports to make sure data entry was proper. If data entry is proper, then there is an inconsistency that is of importance in evaluating the WC claim.

As time passes and the claimant pursues the claim, additional events such as taking a statement from the claimant 101c thus providing information stored at 102c, 103c, 104c, 105c, and 106c, and taking a statement from a witness (or witnesses) thus providing information stored at 101d, 102d, 103d, 104d, 105d, and 106d occur. Note that at 103d, the witness did not confirm or deny the type of pain felt by claimant.

At the checklist arrangement, step 86, it can be seen that the claimant's statement added an injury location at NFL6 (neck, front, left grid, space 6) which will cause an alert as being inconsistent with the medical report and the claimant's initial statement. By contrast, the witness statement is consistent with the initial report and medical report. The claimant's statement of pain at 103c is also inconsistent (now “sharp lasting”) and so are the time of injury (now 4:30 pm), place (work room B) and activity or job duty (reaching).

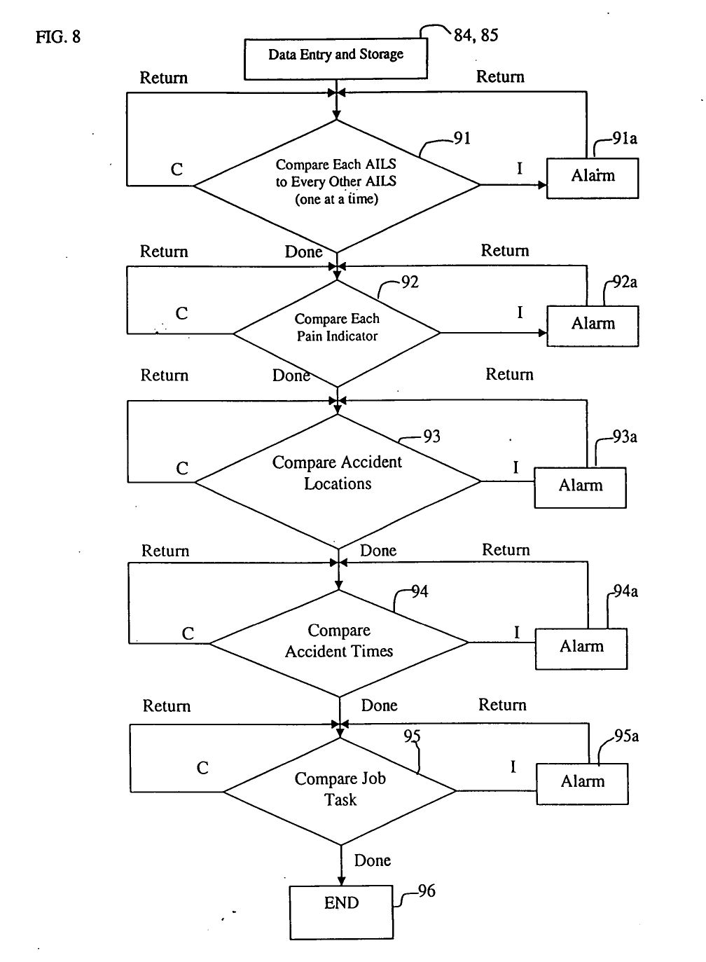

The flow chart of FIG. 8 shows an example of how software for the checklist arrangement 6 and step 86 could perform comparison functions, e.g., upon entry of data and storage thereof (steps 84, 85 of FIG. 6) either when all data is entered from the document, e.g., medical report, from which data is being entered or at each time data is entered. Comparison of AILS occurs at step 91, and an alarm at step 91a occurs when there is an inconsistency. Comparison of Pain Type or Indicator occurs at step 92 and an alarm at step 92a occurs when there is an inconsistency. Comparison of Accident Locations occurs at step 93 and an alarm at step 93a occurs when there is an inconsistenancy. Comparison of accident time (and date) occurs at step 94 and an alarm occurs at step 94a for an inconsistency. Comparison of Job Task occurs at step 95 and an alarm at step 95 for an inconsistency. Then, the routine ends at step 96 when all comparisons for each source of data have been completed.

Not only may the guidance identifier 36 of system 2 require a selection from a universe list of anatomical scheme 12 to provide the AILS 25, but also would preferably require entry of e.g., the following:

1. Acute or chronic injurious exposure;

2. Duration of exposure and dates of such exposure;

3. Coincident activity—work activity or nonwork activity;

4. Consequences of injury—physical symptom list, e.g,, types of pain and extent of pain and an emotional pain or symptom list;

5. Presence or absence of prior medical conditions;

6. Presence or absence of subsequent medical conditions;

7. Occurrence or nonoccurrence of previous injurious exposure;

8. Occurrence or nonoccurrence of subsequent injurious exposure;

9. Prior disability—existence or nonexistence and increase, decrease or same;

10. Subsequent disability—existence or nonexistence and increase, decrease or same.

A variation of FIG. 7 is shown in FIG. 7A.

The data to be entered in a column in the table is for each stage of the claim. First column 301 is for Entry Date (the date the data entry is being made). Second column 302 is the ID (identification code) for the claim record. Third column 303 is for Doc. Date (document date) or document ID if the data is entered from a document. There is a fourth column 304 for DOI (date of injury). Column 305 is for TOI (time of injury), preferably using twenty four hour time. Column 306 is for Gen. Info. (general information), and there may be other columns, such as employer's ID, employee hire date, and termination date, if any. Column 307 is for DOC (date of claim).

Column 308 is for Mech. Injury (mechanism of injury). The Mech. Injury data fields may be selected and entered from a drop down menu, preferably, of all types of injuries such as listed in column 308a of table 350 of FIG. 7B. Other types of mechanisms of injuries might include burn, and puncture. If no type of injury mechanism is specified in the document, then “INV1” (Investigate 1) is selected, indicating that further investigation of the file and/or further information is needed to fill out this data field. If there are additional injuries for which no injury mechanism is specified in the document, then INV followed by the number of injuries lacking a specific mechanism of injury would be selected. E.g., for three injuries which all lack a mechanism, INV3 is selected to enter in the data field. Column 309 is for I (instrumentality causing the injury), e.g., a board, another person, scissors, a saw, a knife, etc. Column 310 is for WC (workers' compensation information) which may represent multiple columns, such as the doctor referral, the date of any workers' compensation claim report, the date of providing a workers compensation form, e.g., DWC-1, to the injured person, etc.

Column 311 is for DOE (date of examination) and column 312 is for D (diagnosis). Column 313 is for A (activity being performed when injury occurred). Column 314 is for LOC (location where the accident occurred). Column 315 is for Other (other injury), which may encompass multiple columns such as prior injury (yes or no, or investigate), subsequent injury (yes or no, or investigate) and prior disability (yes or no, or investigate). Instead of yes or no, one could enter the prior injury, subsequent injury, or prior disability information. Column 316 is for W (witness name(s)). Column 317 is for CDS (current disability status). Column 318 is for Same (was the same body part treated in the past or since the date of the injury?). This entry may be by drop down menu (yes or no, or investigate). See the drop down menu codes in column 318a of FIG. 7B.

Column 319 is for PD (any prior disability based on the same body part?). This entry may be by drop down menu (yes or no, or investigate). See the drop down menu codes in column 319a of FIG. 7B. Column 320 is for ALC (anatomical location code) and may really be four or five columns. See, e.g., columns 320a, 320b, 320c, 320d and 320e with drop down menus. There may also be a column for Diag? (whether there is any doctor diagnosis), and a drop down menu (yes or no, or investigate), as shown at column 321a in FIG. 7B.

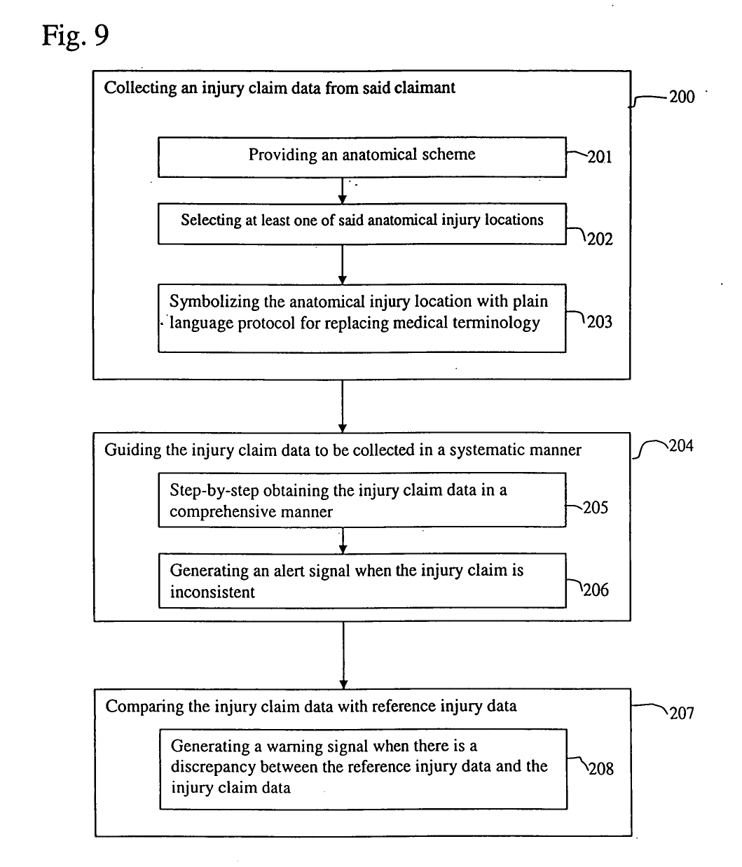

With reference to FIG. 9, there is a second embodiment of the invention, wherein a process for assessing an injury compensation claim made by a claimant is disclosed. This embodiment includes the steps of collecting injury claim data from claimant (step 200), guiding the collection of injury claim data (step 204) in a systematic manner, and comparing the injury claim data with reference injury data (step 207).

In the first step 200, the injury claim data collected contains information of the claimant input at element 3 (FIG. 1) and a standardized code 24 representing a particular body injury of claimant as an evidentiary record 10. The standardized code 24 includes the AILS 25 as described in the previous embodiment. The injury claim data is collected into the standardized information database of the system of assessing injury compensation as disclosed above.

In order for injury claim data to be collected effectively, an anatomical map and code 201 as disclosed above is provided for data-entry personnel to delineate the anatomical location of any injury. This map and code makes identification of the location simple and easy to understand, as distinct from conventional anatomical terms in common use by medical professionals.

The data-entry personnel are able to select one or more anatomical injury location codes from the anatomical scheme to correspond to the body injury allegedly sustained by claimant at step 202.

Also, in order to prevent any subsequent exaggeration, misstatement and/or falsification of the nature of the claim, the anatomical injury location is symbolized in a plain language protocol at step 203. This plain language replaces medical terminology and creates an unambiguous record.

While the injury claim data is collected, the data-entry person is guided by the system, such that the injury claim data is collected in a systematic and consistent manner, enabling validation of the injury claim data. To this end, data-entry personnel are guided by the checklist arrangement disclosed above in step 204 and step 205.

When the injury claim data obtained is inconsistent in any way, an alert signal will be generated to warn a claim evaluator that the claim data is inconsistent at step 206. The evaluator will then be prompted to investigate the injury claim data inconsistency and reasons therefor.

As consistent types of data and complete injury claim data are collected, the injury claim data is compared with reference injury data, representing equivalent facts and circumstances to determine disputed issues of the injury claim data by detecting inconsistent assertions and evidentiary facts in the record, at step 207.

When there is any discrepancy between the reference injury data and the injury claim data, a warning signal will be generated to alert the claim evaluator that the injury claim data will have to be reviewed and investigated at step 208.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

The system may also include, as part of the standardized database and as part of the information the checklist arrangement would prompt for, a disease code entry comprising one or more International Classification of Diseases Codes and/or Diagnostic and Statistical Manual of Mental Disorders Codes, and the injury claim data would include one or more of the indicated disease codes as a part of the record of evidence in a claim of injury and the disease code or codes associated with the injury claim data would automatically be compared with other similar entries in the record to detect the prior, or subsequent occurrence of a same or similar code and hence diagnosis in the same data field, and/or elsewhere in the record.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

1-23. (canceled)

24. A method of encoding a human anatomical location, the method comprising the steps of:
dividing various anatomical sections of a human body into grids having at least a first component to define a location on the body of the grid, a second component to define a location in the grid, such that each location on the body is uniquely defined, and wherein the at least first and second components are expressed by symbols, the symbols being at least one of letters, words, numbers, combinations thereof that uniquely identify human anatomical locations in nonmedical terms, whereby human anatomical locating may be compared and determined to be one of the same and different without ambiguity.

25. The method of claim 24, wherein in the step of dividing, the entire surface of the human body is divided into grids.

26. The method of claim 24, wherein codes for grids on a front of the human body include a code letter “F” and grids on a rear of the human body include a code “B.”

27. The method of claim 26, wherein codes for grids on a top of the human body's foot include a code letter “T” and grids on a bottom of the human body's foot include a code letter “B.”

28. The method of claim 27, wherein codes for the human body's spinal column comprise a first letter of a conventionally used term to define a portion of the spinal column and each vertebrae in each portion of the spinal column is assigned the first letter of the term for that portion and a number counting up from “1.”

29. The method of claim 28, wherein a code for a coccyx is CX and a code for a vertebrae at a small of the back is SM.

30. The method of claim 26 wherein codes for grids on a left side of the human body have an “L” and codes for girds on a right side of the human body have an “R.”

31. The method of claim 30, wherein codes for a grid on a surface on the human body's head comprise a letter “H,” codes for a grid on a surface of the human body's neck comprise an “N.”

32. The method of claim 26, wherein codes for a grid on a surface on the human body's chest comprise a “T,” codes for a grid on a surface of the human body's stomach comprise a “LF,” and codes for a grid on a surface on the human body's back comprise on of a “TB” and an “LB.”

33. The method of claim 26, wherein codes for grids on the human body's arms comprise an “A,” codes for grids on the human body's upper arm comprise a “U,” codes for grids on the human body's lower arm comprise an “L,” codes for a gird on the human body's elbow comprise an “E,” codes for grids on the human body's hands comprise an “H,” and codes for grids on the human body's wrist comprise a “W.”

34. The method of claim 26, wherein codes for a grid on the human body's legs comprise an “L,” codes for grids on the human body's upper leg comprise a “U,” codes for grids on the human body's lower leg comprise an “L,” codes for grids on the human body's knee comprise a “K,” codes for grids on the human body's foot comprise an “F,” and codes for grids on the human body's ankle comprise an “A.”

35. The method of claim 24, wherein grids on the human body are divided into one of nine regions of three by three and three regions in a line.

36. The method of claim 35, wherein the nine regions comprise a first upper row of three regions, a second middle row of three regions and a third lower row of three regions, the regions in each row comprising an inner region closest to a vertical and central axis through the human body, an outer region farthest from the vertical and central axis, and a middle region in between the inner region and the outer region.

37. The method of claim 36, wherein the code as signs a “1” to the inner region in the upper row, a “2” to the middle region in the upper row, a “3” to the outer region in the upper row, a “4” to the inner region in the middle row, a “5” to the middle region in the middle row, a “6” to the outer region in the middle row, a “7” to the inner region in the lower row, an “8” to the middle region in the lower row, and a “9” to the outer region in the lower row.

38. The method of claim 37, wherein the grids at the human body's elbow, knee, wrist and ankle have one row of three regions, having an inner region closest to the vertical and central axis and assigned a letter “I,” an outer section furthest from the vertical and center axis and assigned a letter “O,” and a middle section assigned a letter “M.”

39. The method of claim 38, wherein codes for a grid on the human body have a letter for a body section which comes first in the codes, and at least one of a code for a front or back, and top or bottom of the body section which comes second in the codes, and at least one of the letter and a number for a region in the grid which comes last in the code.

40. The method of claim 24, wherein codes for a grid on the human body have a letter for a body section which comes first in the codes, and at least one of a code for a front or back, and top or bottom of the body section which comes second in the codes, and at least one of the letter and a number for a region in the grid which comes last in the code.

41. The method of claim 26, wherein codes for a grid on the human body have a letter for a body section which comes first in the codes, and at least one of a code for a front or back, and top or bottom of the body section which comes second in the codes, and at least one of the letter and a number for a region in the grid which comes last in the code.

42. The method of claim 30, wherein codes for a grid on the human body have a letter for a body section which comes first in the codes, and at least one of a code for a front or back, and top or bottom of the body section which comes second in the codes, and at least one of the letter and a number for a region in the grid which comes last in the code,

43. The method of claim 25, wherein codes for grids on a front of the human body include a code letter “F” and grids on a rear of the human body include a code “B,” wherein codes for grids on a top of the human body's foot include a code letter “T” and grids on a bottom of the human body's foot include a code letter “B,” wherein codes for the human body's spinal column comprise a first letter of a conventionally used term to define a portion of the spinal column and each vertebrae in each portion of the spinal column is assigned the first letter of the term for that portion and a number counting up from “1,” wherein a code for a coccyx is CX and a code for a vertebrae at a small of the back is SM wherein codes for grids on a left side of the human body have an “L” and codes for girds on a right side of the human body have an “R,” wherein codes for a grid on a surface on the human body's head comprise a letter “H,” codes for a grid on a surface of the human body's neck comprise an “N,” wherein codes for a grid on a surface on the human body's chest comprise a “T,” codes for a grid on a surface of the human body's stomach comprise a “LF,” and codes for a grid on a surface on the human body's back comprise on of a “TB” and an “LB,” wherein codes for grids on the human body's arms comprise an “A,” codes for grids on the human body's upper arm comprise a “U,” codes for grids on the human body's lower arm comprise an “L,” codes for a gird on the human body's elbow comprise an “E,” codes for grids on the human body's hands comprise an “H,” and codes for grids on the human body's wrist comprise a “W,” wherein codes for a grid on the human body's legs comprise an “L,” codes for grids on the human body's upper leg comprise a “U,” codes for grids on the human body's lower leg comprise an “L,” codes for grids on the human body's knee comprise a “K,” codes for grids on the human body's foot comprise an “F,” and codes for grids on the human body's ankle comprise an “A,” wherein grids on the human body are divided into one of nine regions of three by three and three regions in a line, wherein the nine regions comprise a first upper row of three regions, a second middle row of three regions and a third lower row of three regions, the regions in each row comprising an inner region closest to a vertical and central axis through the human body, an outer region farthest from the vertical and central axis, and a middle region in between the inner region and the outer region, wherein the code as signs a “1” to the inner region in the upper row, a “2” to the middle region in the upper row, a “3” to the outer region in the upper row, a “4” to the inner region in the middle row, a “5” to the middle region in the middle row, a “6” to the outer region in the middle row, a “7” to the inner region in the lower row, an “8” to the middle region in the lower row, and a “9” to the outer region in the lower row, wherein the grids at the human body's elbow, knee, wrist and ankle have one row of three regions, having an inner region closest to the vertical and central axis and assigned a letter “I,” an outer section furthest from the vertical and center axis and assigned a letter “O,” and a middle section assigned a letter “M,” wherein codes for a grid on the human body have a letter for a body section which comes first in the codes, and at least one of a code for a front or back, and top or bottom of the body section which comes second in the codes, and at least one of the letter and a number for a region in the grid which comes last in the code.
